(19) United States
(12) Patent Application Publication
(10) Pub. No.: US 2025/0226485 A1
(43) Pub. Date: Jul. 10, 2025

(54) BATTERY MODULE

(71) Applicant: TOYOTA JIDOSHA KABUSHIKI KAISHA, Toyota-shi (JP)

(72) Inventor: Masahiro SAKATA, Nagakute-shi (JP)

(73) Assignee: TOYOTA JIDOSHA KABUSHIKI KAISHA, Toyota-shi (JP)

(21) Appl. No.: 18/911,257

(22) Filed: Oct. 10, 2024

(30) Foreign Application Priority Data
Jan. 9, 2024 (JP) 2024-001442

(51) Int. Cl. H01M 10/6555; H01M 10/615

(52) U.S. Cl. CPC H01M 10/6555; H01M 10/615

(57) ABSTRACT

A battery module includes n stacked battery cells; and m resin separators inserted between the stacked adjacent battery cells, in which at least one of the m resin separators has a heater function capable of generating heat. n represents an integer of 2 or more, and m is represented by the following formula: m=n−1.

### CROSS-REFERENCE TO RELATED APPLICATION

This application claims priority to Japanese Patent Application No. 2024-001442 filed on Jan. 9, 2024, incorporated herein by reference in its entirety.

### BACKGROUND

### 1. Technical Field

The present disclosure relates to the structure of a battery module in which a plurality of battery cells is stacked.

### 2. Description of Related Art

Japanese Unexamined Patent Application Publication No. 2022-086448 (JP 2022-086448 A) discloses a battery module (battery pack) in which a battery stack constituted by stacking a plurality of battery cells is accommodated in a case that serves as a housing. It is indicated that in this battery module, a heater substrate is installed on the bottom surface of the case, and that the lower surface of the battery stack (the bottom wall of each battery cell) is heated when the temperature is low, when performance is deteriorated, for example.

### SUMMARY

In the conventional battery module described in JP 2022-086448 A, a heater substrate is installed on the bottom surface of the case. Therefore, only one surface of the heater substrate is in contact with the battery stack, and heat generated for heating escapes from the other surface that is not in contact with the battery stack. Therefore, in the conventional battery module, there is an issue that the efficiency of heating (heat insulation) of the battery cells is not good.

The present disclosure has been made in view of the above issue, and an object of the present disclosure is to provide a battery module including a heating unit with high efficiency of heating (heat insulation).

In order to address the above issue, an aspect of the technique according to the present disclosure provides
a battery module including:
n stacked battery cells; and
m resin separators inserted between adjacent stacked battery cells, in which:
the n represents an integer of 2 or more;
the m is represented by the following formula:
m=n−1; and
the m resin separators include at least one first resin separator, and the first resin separator has a heater function capable of generating heat.

With the battery module according to the present disclosure, the resin separator having the heater function is provided between the battery cell and the battery cell, and thus the generated heat does not easily escape to the outside, and the efficiency of heating (heat insulation) can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a schematic structure of a battery module according to an embodiment of the present disclosure;

FIG. 2 is an exploded view illustrating the construction of a cell stack; and

FIG. 3 is an exploded three-dimensional view illustrating a structure of a resin separator having a heater function.

### DETAILED DESCRIPTION OF EMBODIMENTS

The battery module of the present disclosure incorporates a heater function in a resin separator inserted between a battery cell having a stacked structure and a battery cell. As a result, since heat is generated between the battery cell and the battery cell, the amount of heat escaping to the outside can be suppressed, so that the battery cell can be heated efficiently.

Hereinafter, an embodiment of the present disclosure will be described in detail with reference to the drawings. Note that, for the purpose of clarity of explanation, as shown in the drawings, the directions of the upper, lower, left, right, front, and rear are defined in advance, and embodiments are described in accordance with this definition.

### Embodiment

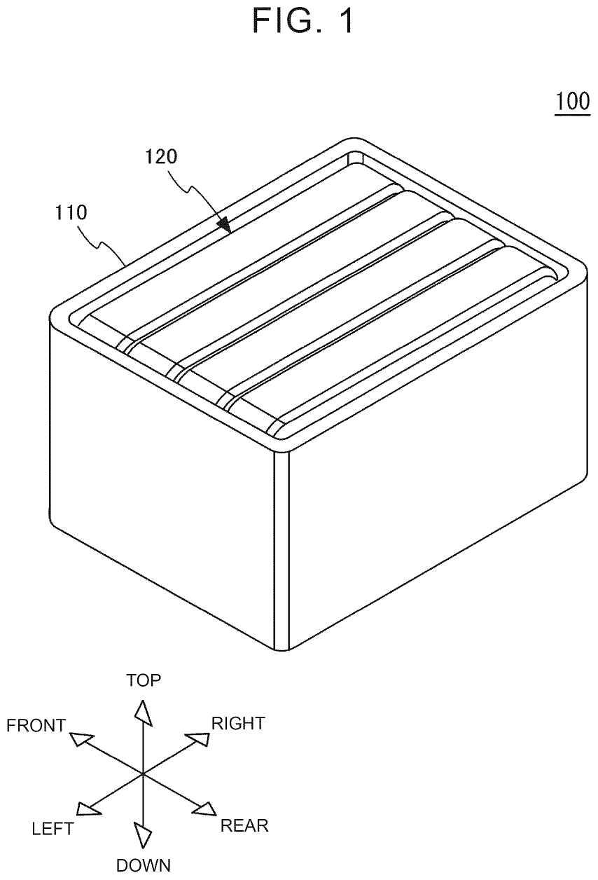

FIG. 1 is a schematic diagram illustrating a structure of a battery module 100 according to an embodiment of the present disclosure. The battery module 100 illustrated in FIG. 1 includes a storage case 110 and a battery stack 120 in a configuration.

The storage case 110 is a substantially box-shaped member formed of an insulating material such as resin and having one surface (upper side) opened. The storage case 110 is a housing for inserting the battery stack 120 from the opening surface and storing the battery stack 120. Although the storage case 110 is provided with various other shapes such as a handle for carrying and a hole for taking out a connection terminal, it is not the main object of the present disclosure technology, and therefore, illustration and description thereof are omitted.

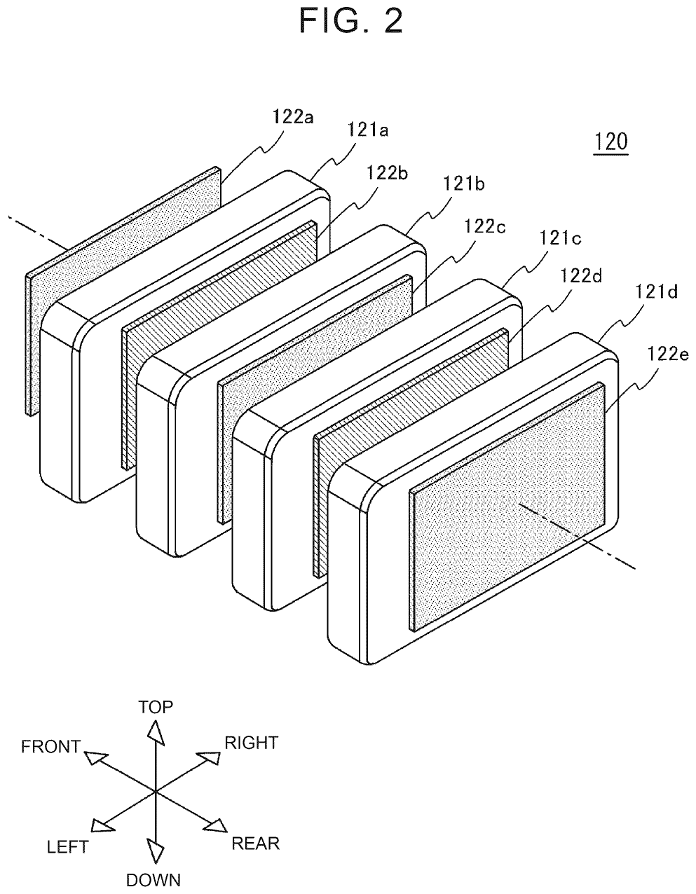

The battery stack 120 is a structure in which a plurality of battery cells is electrically connected. FIG. 2 is an exploded view illustrating a detailed structure of the battery stack 120. The battery stack 120 illustrated in FIG. 2 is a stack in which a plurality of battery cells 121a to 121d and a plurality of resin separators 122a to 122e are alternately stacked in the front-rear direction (stacking direction). Note that the number of the battery cells 121a to 121d stacked as stacked as the battery stack 120 is not limited to the number shown in FIG. 2.

The plurality of battery cells 121a to 121d is, for example, substantially flat-plate-shaped square-shaped unit batteries made of a secondary battery such as a lithium-ion battery.

The plurality of resin separators 122a to 122e is a substantially flat plate-shaped member having an insulating property, such as resin, that can electrically insulate between two adjacent battery cells in a stacked manner among the plurality of battery cells 121a to 121d. 122e from the plurality of resin separators 122a has a spacer function when the battery stack 120 is stored in the storage case 110. The plurality of resin separators 122a to 122e is adjusted as a spacer so that a uniform and constant load is applied to each of the plurality of battery cells 121a to 121d.

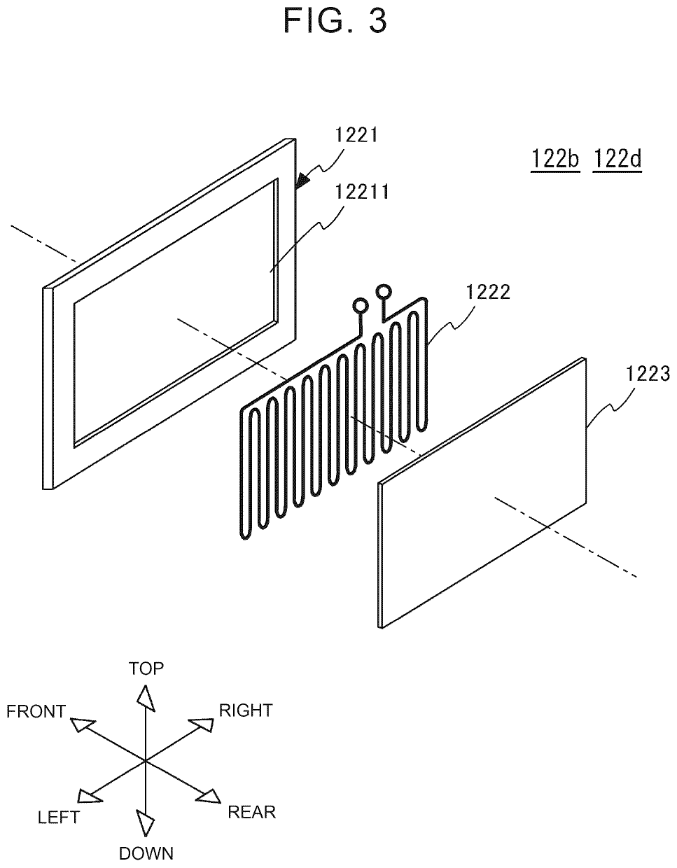

At least one of the plurality of resin separators 122a and 122e has a heater function capable of generating heat. In the present embodiment, the resin separators 122b and 122d have a heater function capable of generating heat. FIG. 3 is an exploded view illustrating a configuration of resin separators 122b and 122d having a heater function. The resin separators 122b and 122d having the heater function shown in FIG. 3 include a base resin plate 1221, a metal heater pattern 1222, and a cover resin plate 1223.

The metal heater pattern 1222 is a heating member formed by forming a wiring of a metal material (for example, copper, aluminum, or stainless steel) that generates heat by energization into a bellows-like pattern. The wire diameter (thickness) of the wire is smaller than the thickness (front-rear direction) of the resin separators 122b and 122d.

The base resin plate 1221 is a substantially flat plate-shaped member having an insulating property such as resin. A recess 12211 for accommodating the metal heater pattern 1222 is formed in a central portion of the base resin plate 1221.

Like the base resin plate 1221, the cover resin plate 1223 is a substantially flat plate-like member having an insulating property such as resin. The cover resin plate 1223 is formed into a shape to be fitted into the recess 12211 of the base resin plate 1221, and is fitted into the base resin plate 1221 from above the metal heater pattern 1222 accommodated in the recess 12211. The fitting may be performed by press-fitting or by bonding.

As described above, the metal heater pattern 1222 is sandwiched between the base resin plate 1221 and the cover resin plate 1223, thereby completing the flat resin separators 122b and 122d having the built-in heater. The metal heater pattern 1222 is disposed at the first position. The first position is a position where the metal heater pattern 1222 is not exposed to the resin so as not to be electrically short-circuited by contacting the battery cells 121a to 121d in the condition of the finished resin separators 122b and 122d. The first position is a position where the metal heater pattern 1222 can uniformly heat both of the battery cells sandwiched therebetween.

### Operations and Effects

In the battery module 100 according to the present embodiment having the above-described configuration, the resin separator 122b having a heater function is interposed between the battery cell 121a and the battery cell 121b. With this arrangement, heat radiation from one surface (front side) of the resin separator 122b that has generated heat heats the battery cell 121a, and heat radiation from the other surface (rear side) of the resin separator 122b that has generated heat heats the battery cell 121b. In the battery module 100, a resin separator 122d having a heater function is interposed between the battery cell 121c and the battery cell 121d. With this arrangement, heat radiation from one surface (front side) of the resin separator 122d that has generated heat heats the battery cell 121c, and heat radiation from the other surface (rear side) of the resin separator 122d that has generated heat heats the battery cell 121d.

That is, in the configuration of the battery module 100 according to the present embodiment, the planes of both the resin separators 122b and 122d are in close contact with each other from the battery cell 121a to 121d. Therefore, the area in which the heat generated by the resin separators 122b and 122d escapes to the outside is reduced as much as possible. Therefore, heat can be efficiently and quickly heated (kept warm) in the battery cells 121a to 121d because it is difficult for heat to escape to the outside.

Further, in the configuration of the battery module 100 according to the present embodiment, the plurality of battery cells 121a to 121d are restrained by the storage case 110 and the plurality of resin separators 122a to 122e at a constant load. Accordingly, the resin separators 122b and 122d, which incorporate the metal heater pattern 1222, can be sufficiently adhered to the plurality of battery cells 121a to 121d. Therefore, the heat conductive sheet required in the structure of the conventional battery module can be omitted.

The present disclosure is applicable to a battery module in which a plurality of battery cells is stacked. In the present disclosure, a resin separator having a heater function may be referred to as a first resin separator, and a resin separator not having a heater function may be referred to as a second resin separator.

What is claimed is:

1. A battery module comprising:
n stacked battery cells; and
m resin separators inserted between adjacent stacked battery cells, wherein:
the n represents an integer of 2 or more;
the m is represented by the following formula:
m=n−1; and
the m resin separators include at least one first resin separator, and the first resin separator has a heater function capable of generating heat.

2. The battery module according to claim 1, wherein:
the m resin separators include one or more second resin separators, and the second resin separators do not have the heater function; and
the first resin separator and the second resin separators are alternately inserted between the battery cells.

3. The battery module according to claim 1, wherein the first resin separator includes a heater pattern made of metal and two resin plates, and the heater pattern is sandwiched between the two resin plates.
